(19) United States
(12) Patent Application Publication
(10) Pub. No.: US 2024/0328870 A1
(43) Pub. Date: Oct. 3, 2024

(54) TEMPERATURE SENSOR

(71) Applicant: KOA CORPORATION, Nagano (JP)

(72) Inventors: Susumu TOYODA, Nagano (JP); Keishi NAKAMURA, Nagano (JP)

(21) Appl. No.: 18/573,823

(22) PCT Filed: May 30, 2022
(86) PCT No.: PCT/JP2022/021910

§ 371 Date: Dec. 22, 2023

(30) Foreign Application Priority Data
Jul. 1, 2021 (JP) 2021-110002

(51) Int. Cl. G01K 7/18; H01C 7/02; H01C 7/22

(52) U.S. Cl. CPC G01K 7/183; H01C 7/02; H01C 7/22

(57) ABSTRACT

Provided is a temperature sensor which can enhance strength more easily. The temperature sensor comprises a resin film and a titanium metal foil laminated on the resin film. The titanium metal foil constitutes a conductive pattern. In an example, the titanium metal foil is subjected to a surface modification on a surface facing the resin film. In an example, a thickness of the titanium metal foil is within a range of 3-10 μm. In an example, the resin film contains a thermoplastic resin, and a thickness of the resin film is within a range of 20-80 μm.

### RELATED APPLICATIONS

This application is a 371 application of PCT/JP2022/021910 having an international filing date of May 30, 2022, which claims priority to JP2021-110002 filed Jul. 1, 2021, the entire content of each of which is incorporated herein by reference.

### TECHNICAL FIELD

The present invention relates to a temperature sensor.

### BACKGROUND ART

There are temperature sensors with various shapes such as chip-like, rod-like, film-like, etc. They generally include a temperature sensitive element which comprises a thin film formed by a method such as sputtering or a thick film formed by a printing method.

As material component for the temperature sensitive element used for a temperature sensor, a thin film of platinum (Pt) or nickel (Ni) is used. Also, a ceramic-based film of an oxide or a nitride is used for a PTC thermistor or an NTC thermistor.

Many temperature sensitive films measure temperatures by utilizing changes in the resistance value due to temperature changes (TCR), and materials with larger absolute values of TCR are preferable. Most frequently used for temperature sensors are Pt films of which TCR is 3850 ppm/° C. Materials having TCRs close to this value are suitable for use in a temperature sensor.

In order to obtain the changes in resistance value due to temperature changes accurately, it is preferable to have a certain high resistance value, and generally, those with resistance values of about 200Ω are frequently used. Although platinum, nickel, etc. have large TCRs, their electrical resistivities (p) are small, so many temperature sensitive films are manufactured as thin films having a thickness in nm order in order to obtain the resistance value of 200Ω.

Lithium (Li) ion batteries mounted in vehicles use plurality of cells combined. Although temperature measurement and current control are performed for the entire battery system, temperature measurement for each cell is not performed, so it is difficult to identify which one of the cells has begun deteriorated. In order to measure a temperature for each cell and identify each degree of deterioration, a temperature sensor with a thin shape are required such that it can be inserted between cells.

Also, regarding a current sensor of a shunt scheme, it is important to improve accuracy of current detection, and for that purpose, the amount of TCR change in the shunt has to be corrected appropriately. As a method therefor, it is effective to measure heat generation in the shunt and correct the resistance value of the shunt based on the measured value to calculate the current value. However, in order to correct the temperature with high accuracy, it is necessary to measure the temperature of a resistive body in the shunt directly, which requires a temperature sensor used in a state wherein it is electrically insulated from and laminated on the resistive body of the shunt.

As an example of a conventional temperature sensor, in Patent Literature 1, a conductive pattern is formed on a film by a thin film of nickel.

### CITATION LIST

### Patent Literature

Patent Literature 1: JP 2020-126034 A

### SUMMARY OF INVENTION

### Technical Problem

However, conventional techniques have a problem that it is difficult to enhance strength of the temperature sensor.

Conventional temperature sensors frequently use platinum because platinum can be used stably in a high temperature and has good weather resistance. However, there is a problem that its cost is high, and it has been excessive quality for use in measuring relatively low temperatures (for example, equal to or less than 200° C.).

Although nickel may be used instead of platinum, nickel has low electrical resistivity (ρ) of 6.9 μΩ·cm. Accordingly, the necessary resistance value cannot be obtained in a state of foil, and it has to be formed as a thin film by sputtering or evaporation. A thin film formed by sputtering or the like has low strength of the film per se, so if it is attached to a thin film-like base material, it is likely to fracture by being bent or stretched. Accordingly, the film has to be formed on a ceramic substrate or the like, which is not suitable in a use which requires a thin temperature sensor.

In the temperature sensor described in Patent Literature 1, the nickel also has a low ρ, so it is formed as a thin film by sputtering or the like. Because of this, it has limitation in mechanical endurance and weather resistance.

Also, in cases wherein a ceramic-based oxide or nitride is used in a thermistor or the like, it is difficult to process it thin and it cannot be bent, so it is not suitable for uses requiring a thin temperature sensor.

The present invention is made in order to solve the foregoing problems and an object thereof is to provide a temperature sensor which can enhance strength more easily.

### Solution to Problem

An example of a temperature sensor related to the present invention comprises a resin film and a titanium metal foil laminated on the resin film, wherein the titanium metal foil constitutes a conductive pattern.

In an example, the titanium metal foil is subjected to a surface modification on a surface facing the resin film.

In an example, a thickness of the titanium metal foil is within a range of 3-10 μm.

In an example, the resin film contains a thermoplastic resin, and a thickness of the resin film is within a range of 20-80 μm.

In an example, the resin film contains a thermosetting resin, and the resin film and the titanium metal foil are laminated via a first adhesion layer.

In an example, the temperature sensor further comprises a metal layer formed on a side opposite to the titanium metal foil with respect to the resin film.

In an example, the temperature sensor further comprises a second adhesion layer formed on a side opposite to the titanium metal foil with respect to the resin film.

The present description includes the contents disclosed in Japanese Patent Application No. 2021-110002, upon which the present application claims priority.

### Advantageous Effects of Invention

A temperature sensor related to the present invention can enhance strength of the temperature sensor more easily.

### BRIEF DESCRIPTION OF DRAWINGS

FIG. 1 shows a side view of a temperature sensor related to Example 1 of the present invention.

FIG. 2 shows a side view of a temperature sensor related to a modified example for Example 1.

FIG. 3 shows a plan view of the temperature sensor of FIG. 1.

FIGS. 4A, 4B and 4C are diagrams showing a method for producing the temperature sensor of FIG. 1.

FIG. 5 is a graph showing exemplary performance of the temperature sensor of FIG. 1.

FIG. 6 shows a side view of a temperature sensor related to a modified example for Example 1.

FIG. 7 shows a side view of a temperature sensor related to a modified example for Example 1.

FIG. 8 shows a perspective view indicating an exemplary use of the temperature sensor of FIG. 1.

FIG. 9 shows a plan view of a temperature sensor related to Example 2 of the present invention.

FIG. 10 shows a plan view indicating an exemplary use of the temperature sensor of FIG. 9.

### DESCRIPTION OF EMBODIMENTS

Examples of the present invention will be explained below based on the attached drawings.

### Example 1

The present inventors had a concept of using titanium (Ti) metal foil in a temperature sensitive element and laminate it on a film-like base material to form a thin temperature sensor. Techniques for processing a metal foil thin has been advanced and a foil with a thickness of 3 μm or more is relatively readily available. The thickness of a foil is, for example, 10 times or more of that of a thin film, so its resistance value is lower compared with that of the thin film. However, a titanium metal foil has a high p, so a resistance value sufficiently high can easily be obtained.

Although it is contemplated that an alloy is used as a material with high ρ. However, it is expected that the TCR of the alloy would be about 2000 ppm/° C. or lower.

Titanium has ρ of 53 μΩ·cm, which is 5 times or more of p of Pt (9.9 μΩ·cm). Also, titanium exhibits TCR of about 4000 ppm/° C., so it has characteristics suitable for use as a temperature sensor. By laminating a 5 μm titanium metal foil on a film of 20-80 μm thickness and then pattern processing it appropriately, a resistance value of 200Ω can be obtained with a size of about 5 mm×9 mm, so a very thin temperature sensor can be obtained.

Such a thin temperature sensor can be used inserted between battery cells by shaping it film-like. Also, it can be used with good adaptability even if it is laminated on a non-smooth surface. Conventional temperature sensors using a sputtered film or a ceramic film have bad adaptability so that they can be used only on a planer surface, whereas a titanium metal foil has high strength even if it is thin, so a temperature sensor can be used laminated on a portion having a curved surface.

The temperature sensor related to Example 1 can be constructed as a film-like thin sensor. Also, it can be laminated on a measurement target in a state wherein it is electrically insulated therefrom. Further, even if it is thin, strength against deformation (bending, etc.) is ensured.

Titanium is used, for example, processed in a thin metal foil-like shape, and the thickness is, for example, within a range of 3-10 μm. A resin film as an insulating layer can be laminated thereon. The thickness of the resin film for insulation is, for example, within a range of 20-80 μm. Within this thickness range, a state wherein it has shape adaptability can easily be ensured. First, a titanium metal foil is laminated on a resin film, and then the titanium metal foil is subjected to photolithography and etching to form a conductive pattern, resulting in a shape wherein a resistance value of 200Ω is obtained.

On the insulating film, an adhesion layer may be formed on a surface opposite to the titanium metal foil. In this construction, it can be laminated on a surface of a measurement target.

Shape adaptability can be ensured by using the titanium metal foil as the temperature sensitive element, and it can be bent for example. Also, mechanical endurance and weather resistance can be ensured. The thickness of the entire temperature sensor can be 100 μm or less so that a thin temperature sensor can be obtained.

In particular, by using titanium, which is a single metal, resistance characteristics can be stable and deviation in TCR value can be suppressed small, so a temperature sensor with high accuracy can be obtained.

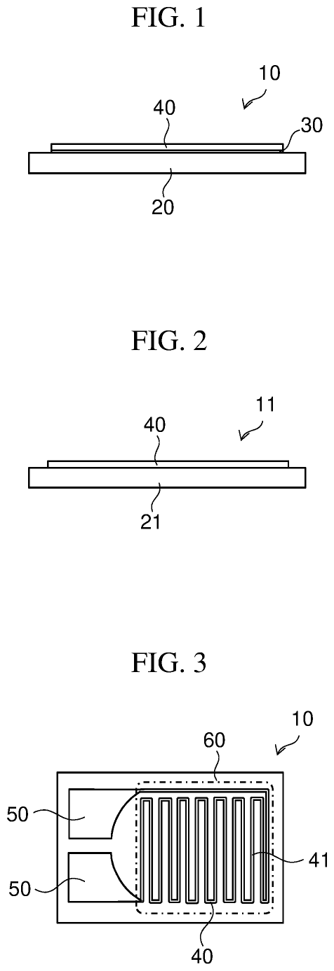

FIG. 1 is a side view of a temperature sensor 10 related to Example 1 of the present invention. The temperature sensor 10 comprises a resin film 20 and a titanium metal foil 40 laminated on the resin film 20. In the example of FIG. 1, the temperature sensor 10 further comprises a first adhesion layer 30, and the resin film 20 and the titanium metal foil 40 are laminated via the first adhesion layer 30.

In a case wherein a measurement target is conductive (e.g. a shunt resistor or the like), it is preferable to secure insulation by the resin film 20 between the temperature sensitive element portion including the titanium metal foil 40 and the measurement target. In such a case, the thickness of the resin film 20 can be designed in accordance with a required dielectric voltage.

It is preferable that the thickness of the titanium metal foil 40 is 3 μm or more because it is technically difficult to process it to be less than 3 μm and, for example, the cost would increase. On the other hand, it is preferable that the thickness of the titanium metal foil 40 is 10 μm or less because it is difficult to obtain a high resistance value if the thickness is more than 10 μm. Thus, it is preferable that the thickness of the titanium metal foil 40 is within a range of 3-10 μm, and for example, it is more preferable that it is 5 μm.

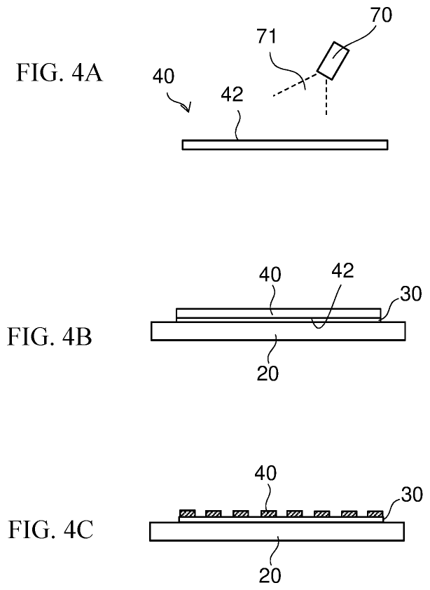

A surface of the titanium metal foil 40 may be subjected to a surface modification (detailed later referring to FIGS. 4A-4C). For example, the titanium metal foil 40 may be subjected to the surface modification on a surface facing the resin film 20. For example, if the surface of the titanium metal foil 40 is roughened by the surface modification, adhesiveness with the resin film 20 can be enhanced.

The surface modification may be performed on the resin film 20 instead of the titanium metal foil 40. That is, a surface of the resin film 20 facing the titanium metal foil 40 may be subjected to the surface modification. In this construction also, adhesiveness between the titanium metal foil 40 and the resin film 20 is enhanced.

If the dielectric voltage of the temperature sensor 10 does not need any consideration, the thickness of the resin film 20 can be determined considering ease of handling of the film, etc. If the thickness of the resin film 20 is less than 20 μm, the material is excessively soft so that it is difficult to handle, and generally market supply becomes smaller and this leads to cost increase, so it is preferable that the thickness is 20 μm or more. On the other hand, if the thickness is 100 μm or more, it is too hard to obtain appropriate flexibility, so it is preferable that, for example, the thickness is 80 μm or less. Thus, it is preferable that the thickness of the resin film 20 is within a range of 20-80 μm, and for example, more preferable that it is within a range of 25-50 μm.

Also, it is preferable that the resin film 20 has a certain heat resistance (about 200° C.). Accordingly, it is preferable to be a resin with a relatively high heat resistance such as polyimide or epoxy. In this case, the first adhesion layer 30 may be used in order to laminate the titanium metal foil 40 and the resin film 20. It is preferable that the first adhesion layer 30 is as thin as possible, and for example, preferable in a range of 10-20 μm.

In the present example, the resin film 20 contains a thermosetting resin, and for example, an entire portion thereof consists of the thermosetting resin. If the resin film 20 of the thermosetting resin is to be used, it is preferable that the titanium metal foil 40 and the resin film 20 are laminated via the first adhesion layer 30 as shown in FIG. 1.

FIG. 2 is a side view of a temperature sensor 11 related to a modified example for Example 1. In the example of FIG. 2, a thermoplastic resin film 21 is used instead of thermosetting resin film 20 shown in FIG. 1.

In the example of FIG. 1, the resin film 20 and the titanium metal foil 40 are laminated indirectly via the first adhesion layer 30. In the example of FIG. 2, the resin film 21 and the titanium metal foil 40 are laminated directly, that is, in contact with each other.

The resin film 21 contains a thermoplastic resin, and for example, an entire portion thereof consists of the thermoplastic resin. It is preferable to use a resin with relatively high heat resistance (polyamide imide, polycarbonate, Teflon®, etc.) as the thermoplastic resin.

By using the thermoplastic resin film 21, it is possible to thermo-compression-bond the titanium metal foil 40 and the resin film 21, so the intervening adhesion layer (for example, the first adhesion layer 30 of FIG. 1) can be omitted. Note that, even if the thermoplastic resin film 21 is used, it is also possible to perform adhesion by the first adhesion layer 30 in a manner similar to the example of FIG. 1.

FIG. 3 shows a plan view of the temperature sensor 10 (a plan view of the temperature sensor 11 of FIG. 2 would be similar). The temperature sensor 10 comprises a temperature sensitive element portion 60 and two terminal portions 50. The temperature sensitive element portion 60 includes the titanium metal foil 40. The titanium metal foil 40 constitutes a conductive pattern and the terminal portions 50 are connected to respective ends of the conductive pattern.

The conductive pattern means a conductive portion (for example, a portion constituted by titanium) shaped into a predetermined shape pattern. The conductive pattern of FIG. 3 includes a plurality of straight conductive sections 41 parallel to each other. Also, within the conductive pattern, these straight conductive sections 41 are electrically serially connected so that a single back-and-forth pattern is formed by the straight conductive sections 41. Note that the conductive pattern may include a curve. Also, the conductive pattern is not limited to those including the back-and-forth pattern shown in FIG. 3 and may include a spiral pattern (rectangular, circular, etc.).

It is preferable that the titanium metal foil 40 does not become open-circuit even if it is bent, considering that it is used together with the resin film 20. Accordingly, it is preferable that the width of the conductive pattern (for example, the width of the straight conductive section 41) has a certain large size. On the other hand, a high resistance value (for example, about 200Ω) may be required for the temperature sensor, so it may be required to narrow the width to some extent in order to increase the resistance value in producing a small sensor.

If the thickness of the titanium metal foil 40 is set to be 5 μm, in order to realize the resistance value of 200Ω in an exemplary construction, the width of the conductive pattern has to be 150 μm or less. Also, in order to ensure mechanical strength, it is preferable that the width of the conductive pattern is 50 μm or more. Accordingly, it is preferable that the width of the conductive pattern of the titanium metal foil 40 is within a range of 50-150 μm. Further, considering difficulty in pattern forming by etching, it is more preferable that the width of the conductive pattern is 100 μm.

We were able to obtain a resistance value of 220Ω by constructing the temperature sensor 10 with the size of 5.5 mm×10 mm using the conductive pattern shown in FIG. 3. According to this resistance value, it can be said that the temperature sensor 10 can be used laminated on a measurement target such as a shunt resistor for a high-current use.

Thus, the temperature sensor 10 related to Example 1 uses the titanium metal foil 40, so the strength is enhanced. For example, the conductive pattern can be formed thicker compared with a case wherein nickel is used.

Also, the titanium metal foil 40 is metal, so a higher shape adaptability can be obtained compared with a case wherein the temperature sensitive element portion 60 is constructed by a sputtered film or a ceramic film.

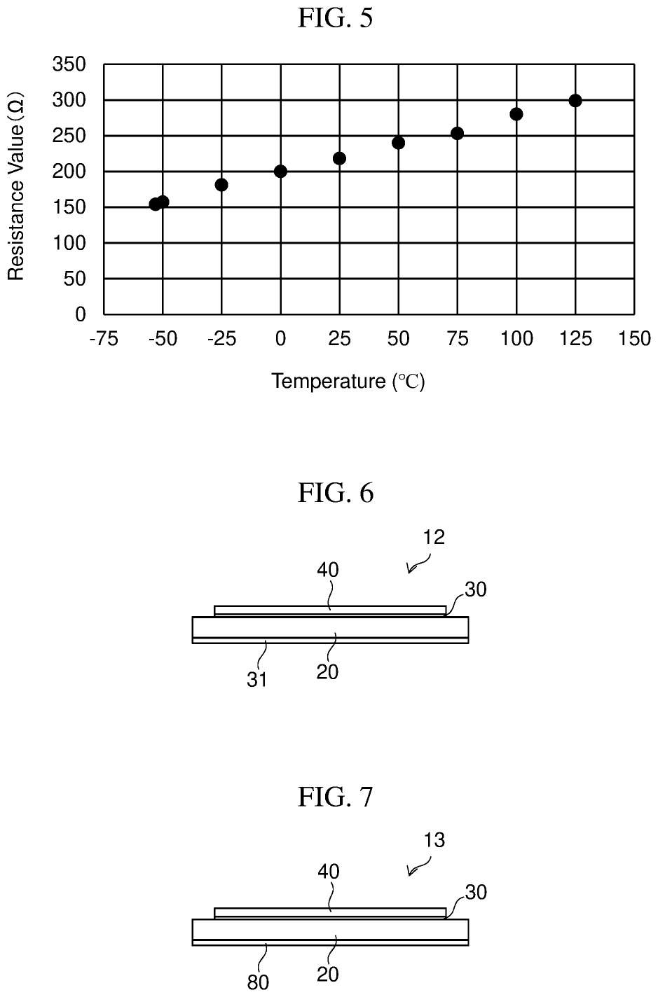

Also, the titanium metal foil 40 is comprised of a single element, so a higher TCR can be obtained compared with a case wherein an alloy is used (detailed later with reference to FIG. 5).

Also, the resin film 20 is used, so the entire temperature sensor can be formed thinner compared with a conventional technique using a ceramic substrate, so limitation on use is reduced. For example, it can be inserted between cells in a lithium-ion battery.

Also, the temperature sensor 10 does not contain platinum, so the cost can be reduced. However, in a case wherein, for example, the cost is not a problem, it can be constructed with platinum contained.

FIGS. 4A-4C show a method for producing the temperature sensor 10. First, as shown in FIG. 4A, one of surfaces of the titanium metal foil 40 is subjected to a surface modification.

As an example of the surface modification, a surface (for example, a surface facing the resin film 20) of the titanium metal foil 40 may be roughened by forming an oxide film 42 thereon. The oxide film 42 can be formed, for example, by irradiating ultraviolet ray 71 by an ultraviolet irradiation apparatus 70. Alternatively, the oxide film 42 can be formed by plasma treatment.

Although the oxide film 42 is shown as a surface without any thickness in FIGS. 4A-4C, the thickness of the oxide film 42 can be within a range of 0.01-0.05 μm.

In a modified example, both surfaces of the titanium metal foil 40 may be roughened. Note that, if both surfaces are roughened, it might be difficult to form the conductive pattern by etching, so this is preferable in a case wherein etching is not used. Note that, the surface modification is not limited to processes for forming the oxide film 42 or processes for roughening the surface.

Next, as shown in FIG. 4B, the titanium metal foil 40 and the resin film 20 are laminated. Upon laminating, they are laminated so that the surface of the titanium metal foil 40 subjected to the surface modification (the oxide film 42 in the example of FIGS. 4A-4C) faces the resin film 20 (note that the titanium metal foil 40 is rotated between FIG. 4A and FIG. 4B so that it is inverted upside down). Upon this, the first adhesion layer 30 may intervene as shown in FIG. 4B, or the first adhesion layer 30 may be omitted in a case no adhesion layer is required.

Next, as shown in FIG. 4C, the conductive pattern is formed on the titanium metal foil 40. FIG. 4C is a partial cross-sectional view and shows a cross section for the titanium metal foil 40. Formation of the conductive pattern may be performed by, for example, etching.

FIG. 5 is a graph showing exemplary performance of the temperature sensor 10. As described above, a resistance value of 220 Ω can be obtained by constructing the temperature sensor 10 with a size of 5.5 mm×10 mm using the conductive pattern shown in FIG. 3. FIG. 5 shows measurement results of changes in the resistance value with respect to temperature using the temperature sensor 10.

Good linearity is confirmed for the resistance values within a temperature range of −50 to 125° C. A TCR obtained from the inclination of this graph is about 3700 ppm/° C., which is a value close to the TCR of platinum used typically.

In the temperature sensor 10 related to Example 1, an additional layer may be formed on a surface of the resin film 20 facing the measurement target.

Such modified examples will be explained below. Explanation on portions common with Example 1 may be omitted. Also, the modified examples below can be combined with the above modified examples including the temperature sensor 11.

FIG. 6 is a side view of a temperature sensor 12 related to a modified example for Example 1. The temperature sensor 12 comprises a second adhesion layer 31. The second adhesion layer 31 is formed on a side opposite to the titanium metal foil 40 with respect to the resin film 20. That is, the second adhesion layer 31 is formed on a surface of the resin film 20 on a side of the measurement target.

Such a temperature sensor 12 can be fixed easily to the measurement target, so a degree of freedom in a fixing method is enhanced. Generally, if the resin film 20 is a thermoplastic film, the temperature sensor 12 can be laminated on the measurement target while the temperature sensor 12 is being heated to a temperature higher than the glass transition point and being pressurized. However, in such a method, the titanium metal foil 40 may be detached depending on the construction. Also, the measurement target will also be heated to a temperature close to 300° C., which might be a problem. Regarding this, the temperature sensor 12 of FIG. 6 comprises the second adhesion layer 31, so it can be fixed to the measurement target without heating, and a degree of freedom in a fixing method is enhanced.

It is preferable that the thickness of the second adhesion layer 31 is thin in order to reduce an entire size of the temperature sensor 12. For example, 10 μm is suitable.

FIG. 7 is a side view of a temperature sensor 13 related to a modified example for Example 1. The temperature sensor 13 comprises a metal layer 80. The metal layer 80 is formed on a side opposite to the titanium metal foil 40 with respect to the resin film 20. That is, the metal layer 80 is formed on a surface of the resin film 20 on a side of the measurement target.

Such a temperature sensor 13 is suitable in a case wherein the measurement target is an electronic component. In a case wherein the measurement target is an electronic component (for example, a shunt resistor), it may be convenient to use soldering implementation for fixing. In such a case, the metal layer 80 may be provided and fixation by solder may be performed. The metal layer 80 may be, for example, a copper foil.

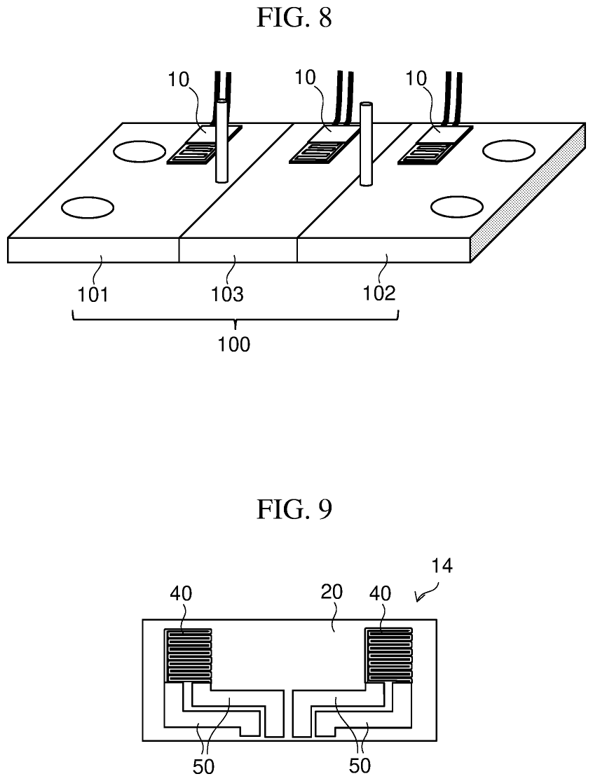

FIG. 8 is a perspective view indicating an exemplary use of the temperature sensor 10 related to Example 1. Although this figure shows the temperature sensor 10 related to Example 1, it is applied to the temperature sensors in the above modified examples similarly.

In the example of FIG. 8, three temperature sensors 10 are attached to a shunt resistor 100. The shunt resistor 100 comprises an electrode 101 (for example, a positive electrode), an electrode 102 (for example, a negative electrode) and a resistive body 103. The temperature sensors 10 are attached to the electrode 101, the electrode 102 and the resistive body 103 respectively.

In the example of FIG. 8, the temperature sensors 10 are attached to all of the electrode 101, the electrode 102 and the resistive body 103. However, it can also be constructed so that the temperature sensor 10 is attached only to the resistive body 103.

### Example 2

FIG. 9 is a plan view of a temperature sensor 14 related to Example 2 of the present invention. In Example 2, a plurality of conductive patterns are formed at respectively different positions in Example 1 or a modified example thereof. Explanation on portions common with Example 1 or any modified example thereof may be omitted.

The temperature sensor 14 comprises one resin film 20 and two titanium metal foils 40. Each titanium metal foil 40 constitutes a conductive pattern. In particular, the titanium metal foils 40 operate as respectively different elements and can measure temperatures at different positions.

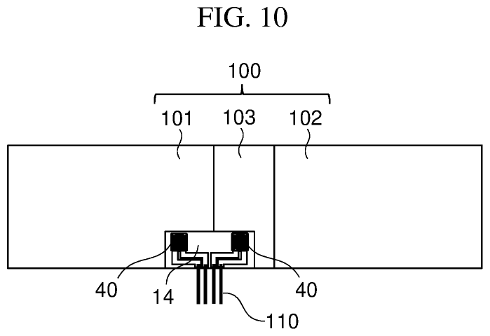

FIG. 10 is a plan view indicating an exemplary use of the temperature sensor 14. In this example, one of the two titanium metal foils 40 is attached to the electrode 101 and the other of them is attached to the resistive body 103. In this construction, temperatures of two different components (the electrode 101 and the resistive body 103 in the example of FIG. 10) in the shunt resistor 100 can be measured by a single temperature sensor 14.

All publications, patents, and patent applications cited in this specification are incorporated herein by reference in their entirety.

1. A temperature sensor comprising a resin film and a titanium metal foil laminated on the resin film, wherein the titanium metal foil constitutes a conductive pattern.

2. The temperature sensor according to claim 1, wherein the titanium metal foil is subjected to a surface modification on a surface facing the resin film.

3. The temperature sensor according to claim 1, wherein a thickness of the titanium metal foil is within a range of 3-10 μm.

4. The temperature sensor according to claim 1, wherein:
the resin film contains a thermoplastic resin; and
a thickness of the resin film is within a range of 20-80 μm.

5. The temperature sensor according to claim 1, wherein:
the resin film contains a thermosetting resin; and
the resin film and the titanium metal foil are laminated via a first adhesion layer.

6. The temperature sensor according to claim 1, wherein the temperature sensor further comprises a metal layer formed on a side opposite to the titanium metal foil with respect to the resin film.

7. The temperature sensor according to claim 1, wherein the temperature sensor further comprises a second adhesion layer formed on a side opposite to the titanium metal foil with respect to the resin film.
